(19) United States
(12) Patent Application Publication
(10) Pub. No.: US 2024/0010296 A1
(43) Pub. Date: Jan. 11, 2024

(54) SINGLE PIVOT SUSPENSION DEVICE FOR FRONT STEERING WHEEL, THE DEVICE BEING PROVIDED WITH A TORQUE LINK AND A SPECIFIC CALIPER SUPPORT MEMBER FOR MOUNTING STANDARD ELEMENTS

(71) Applicant: Newtton, Fareins (FR)

(72) Inventor: Matthieu Alfano, Fareins (FR)

(21) Appl. No.: 18/264,645

(22) PCT Filed: Feb. 14, 2022
(86) PCT No.: PCT/FR2022/050264

§ 371 Date: Aug. 8, 2023

(30) Foreign Application Priority Data
Feb. 14, 2021 (FR) 2101394

(51) Int. Cl. B62K 25/24; B62L 1/00

(52) U.S. Cl. CPC B62K 25/24; B62L 1/005

(57) ABSTRACT

In the field of vehicle suspension, theoretically, single pivot architecture is the simplest way to produce a suspension. However, in practice, this requires specific parts to manage the forces associated with the braking system, which creates a complicated architecture that is incompatible with standard interface elements. The device according to the present disclosure has a specific caliper support member enabling this type of suspension to be considerably simplified and optimized. The device is provided with a single pivot rocker, which provides a single degree of freedom for the front wheel to move in an arc, a caliper support member connected to the rocker by a pivot joint coaxial with the wheel axis and a torque link connecting the rocker to the fork frame by pivot or ball joints. The device according to the present disclosure is particularly suitable for front steering wheel suspension, for motorcycles, bicycles, two-wheeled vehicles, etc.

### CROSS-REFERENCE TO RELATED APPLICATIONS

This application is a national phase entry under 35 U.S.C. § 371 of International Patent Application PCT/FR2022/050264, filed Feb. 14, 2022, designating the United States of America and published as International Patent Publication WO 2022/171968 A1 on Aug. 18, 2022, which claims the benefit under Article 8 of the Patent Cooperation Treaty to French Patent Application Serial No. FR2101394, filed Feb. 14, 2021.

### TECHNICAL FIELD

The present disclosure relates to the field of vehicle suspensions, and, in particular, the suspension of front drive wheels, for motorcycles, cycles, two-wheeled vehicles, etc.

The present disclosure relates more particularly to a device for the use of a suspension architecture of the “single-pivot with a torque link” type while retaining a standard mounting of the wheel and the brake caliper, by improving the compactness of the complete system, by reducing the number of parts and by optimizing the path of the forces in each part.

### BACKGROUND

Front suspensions of cycles are mainly of the telescopic type. This technology, which has long been perfectly understood, has intrinsic limits. Indeed, cylindrical sliding joints (right circular cylindrical), which allow telescoping, are incapable of transmitting guide forces (i.e., twisting forces along the axis of the cycle steering column), which necessarily requires two interconnected legs with significant diameters, thus limiting the amount of mass that can be saved. In addition, these sliding joints have operating friction that it is impossible to completely eliminate, which is detrimental to the comfort and adherence performance of the suspension, as well as inevitable wear of these elements, which causes the system to come loose.

It is possible to overcome these problems by developing suspensions based on pivot joints and not sliding ones. A pivot joint has the advantage of having a single degree of freedom. It therefore allows movement in a single direction (rotation around its axis), and transmits the forces in all other directions. This type of joint is ideal for the design of a suspension whose kinematics must ultimately have a single degree of freedom. In addition, there is a large number of standard elements of pivot joints, allowing various design choices depending on different requirements (mass, reliability, friction, cost, stiffness, etc.). Suspensions designed from these pivot connecting elements (sometimes partially associated with ball joints if torque transmission is not necessary) are said to be “articulated.” There are a large number of articulated forks, the simplest design of which is the “single-pivot” type. Single-pivot kinematics are based on the use of a single part called the rocker or oscillating arm, ensuring the connection between the wheel and the frame of the cycle by a single pivot. The trajectory of the wheel (relative to the frame of the cycle) is therefore an arc. The resilient element (necessarily present on any suspension and referred to as a “spring”), as well as the dissipative element (present on certain more advanced models and generally referred to as a “damper”), or both of these elements (which will be referred to as a “damper” for reasons of simplicity in the rest of the present disclosure) are positioned between the rocker and the fork frame. There are two types of single-pivot kinematics, one in which the main pivot point (the axis O) is located behind the wheel axis (i.e., between the front wheel axis and the rear wheel axis), which will be referred to as “front-rocker” single-pivot kinematics, and one whose axis O is situated in front of the wheel axis, which will be referred to as “rear-rocker” single-pivot kinematics. Note that regardless of the technologies used, the wheel axis is always offset forward relative to the axis of the steering bushing of the chassis (frame) in order to obtain a positive trail that is necessary for the dynamic stability of the vehicle. In the case of “rear-rocker” kinematics, the axis O in front of the wheel axis entails larger parts and an additional cantilever that is at cross-purposes with optimization. The purpose of the present disclosure being to optimize this type of suspension, the concern is only with “front-rocker” single-pivot kinematics, which are intrinsically more compact. In general, single-pivot kinematics are limiting in terms of geometry (trajectory, wheel offset, trail, etc.) but its extreme design simplicity has considerable advantages in terms of reliability, mass, comfort and grip (thanks to the possible use of integral bearings), guidance (torsional rigidity), or even production cost. However, though such single-pivot kinematics are widely used for rear suspension, this is not currently the case for front suspensions because an intrinsic phenomenon then makes it virtually unusable. Indeed, on kinematics with a single connecting part between the wheel and the frame, the braking system (which must necessarily be connected to the wheel) is necessarily also attached to this element (the rocker). During braking, the braking torque is then directly retransmitted to the rocker, which induces an uncontrolled compression or expansion of the suspension (depending on the position of the rotation axis of the rocker), which greatly hinders its operation. For a rear suspension, the braking forces are small and the rocker can “naturally” be positioned such that the lever arm acting on the compression of the suspension is low. However, for a front suspension, this phenomenon is so important that it makes it virtually unusable. This is due on the one hand to the much higher braking power on the front wheel relative to the rear wheel, and on the other hand to the impossibility of placing the pivot point of the rocker sufficiently far from the wheel axis, for reasons of space, inertia (related to guiding) and design.

A known solution consists of not directly connecting the braking system to the rocker, but rather to, on the one hand, the wheel axis via a pivot joint, and on the other hand, the frame by means of a “torque” link. In such a case, the braking torque is no longer retransmitted to the rocker. The principle was used on certain motorcycles between the 1960s and 1980s. Braking systems at the time were of the drum type. The braking system was therefore “naturally” installed around the wheel axis and the adaptation of a torque link connecting this system to the frame was easy. When disc brakes became more common, it would have been too expensive to develop a specific caliper attached to the wheel axis (the standard calipers attach to the frame and not to the wheel axis). In addition, the joint itself between the wheel and the suspension would not have been standard. This non-standard technology therefore did not survive the market for telescopic forks. Today, there are no longer any single-pivot front suspensions on the two-wheeled vehicle market.

### BRIEF SUMMARY

The device according to the present disclosure allows the design of a front steering wheel suspension of the single-pivot type with a “front rocker” having a torque link, compatible with a standard mounting of the wheel and the braking system.

In addition, the device according to the present disclosure makes it possible to optimize the suspension's position, arrangement and number of parts, allowing significant savings in terms of mass, reliability, production cost and integration.

To this end, the device according to the present disclosure comprises a first rigid part, called a fork frame, connected to the frame of the cycle (or chassis) at the steering column thereof by a standard pivot joint, which ensures the degree of freedom necessary to transmit the guiding movements of the vehicle, and a second rigid part, called the rocker, connected on the one hand to the fork frame by a pivot joint whose axis of rotation is parallel to the axis of rotation of the wheel (also called the wheel axis below) and located behind the latter (i.e., toward the rear wheel), and on the other hand to the wheel via a connection of the embedded type. The wheel, of course, has its own rotation system, the hub. It is the hub that is linked via an embedded connection to the rocker, and it is the hub that ensures the rotation of the mobile part of the wheel. For the sake of simplicity, only the wheel will be referred to in the rest of the present disclosure and not to its elements (hub, rim, etc.), while not forgetting that the wheel itself performs its rotation. In addition, “wheel axis” will refer to the geometric axis, i.e., a direction and positioning, rather than the gripping part used to connect the wheel and the rocker. It will be noted that the pivot joint between the fork frame and the rocker (whose geometric axis will be called “axis O” in the rest of the present disclosure) is sufficient to perfectly define the kinematics of the wheel, i.e., its movement. This is why “single-pivot kinematics” is used. The trajectory of the wheel is an arc included in a plane normal to the wheel axis. It is also noted that this kinematics may have either a single arm, the wheel being connected to the rocker on a single side (then referred to as single-arm fork), or two arms, the wheel being connected by its two sides. In the second case, the rocker can be either single and itself have two arms (one on each side of the wheel), or double, in which case they will be referred to as the left rocker and right rocker. The axis O can be produced by several concentric pivots, which may or may not belong to the same rockers. These various potential “architectures” have no influence on the kinematics and operation of embodiments of the present disclosure. In the remainder of the present disclosure, focus will be on the side having the braking system and whether the other side has an arm or not will be ignored.

According to a first feature, the device has a rigid part, called a caliper support, having a compatible interface to accommodate the mounting of a standard brake caliper. This caliper support is connected on the one hand to the rocker by a pivot joint coaxial to the wheel axis, and on the other hand to a torque link by a pivot joint, the torque link itself being connected to the fork frame by another pivot joint, so that the segments connecting these joints and the rocker's joint to the fork frame form a non-intersecting convex quadrilateral with a degree of freedom allowing the wheel axis to move in a plane normal to its direction. It will be noted that these pivot joints (with the exception of the joint between the rocker and the fork frame) can be replaced by ball joints if one of the joints allows the transfer of the “lateral” forces (i.e., not included in a plane normal to the wheel axis) toward the fork frame, i.e., if at least either the joint between the rocker and the caliper support or the joint between the torque link and the fork frame is of the pivot type.

According to a second feature, the rocker (according to a single-arm architecture or not) is in direct contact with the wheel, and has an embedded connection that can be disassembled with the wheel, according to existing standards. Thus, in the case of a left rocker and a right rocker, those rockers are in an embedded connection by means of the wheel.

According to one particular embodiment, the damper is connected to the caliper support (and not to the rocker, contrary to existing designs) by a joint adapted to its operation. Connecting the damper to the caliper support has several advantages. The first advantage is that the caliper support is intrinsically a part that can withstand large forces because braking forces are often decisive to the design of a fork. The caliper support is therefore already sized and can withstand the stresses related to the damper. The rocker is then relieved of this joint and its associated stresses and can be simplified and lightened. The mass of each part is thus optimized. The second advantage is that the caliper support will intrinsically move in circular translation instead of in rotation (because the initial goal of the architecture with the torque link is that the caliper does not rotate to transmit its torque to the kinematics). Thus, the joint with the damper undergoes very little movement, and can be optimized by replacing, for example, a rolling bearing (heavy and expensive) with a less heavy, less expensive, or more compact element of the bearing type, a flexible joint (elastomer, “silent block,” glass fiber, etc.) or even by a simple embedded joint.

According to a particular embodiment, the joints on the caliper support of the damper and the torque link are coaxial. This limits the number of parts and increases compactness, reduces the mass of the assembly and the cost, and finally increases reliability.

According to one particular embodiment, the caliper support is positioned on the inner side of the rocker, i.e., between the rocker and the wheel, and in such a way that its joint interface with the rocker is located on a diameter greater than or equal to that of the joint interface between the wheel and the rocker. In this position, the caliper support is as close as possible to the brake disc and as well-aligned as possible with the brake caliper, which limits the lateral forces that braking could induce and thus makes it possible to optimize the shape, mass, and cost of the caliper support. If the damper is connected to the caliper support, this position also makes it possible to limit the cantilever of the compressive forces emanating from the wheel and allows for an optimization of the shape, mass and cost of the rocker, which then recovers less torsion force. Finally, this position of the caliper support makes it possible to increase the compactness of the mechanism.

According to a particular embodiment, the caliper support and/or the joint interface of the caliper support with the rocker has/have a radial opening (with respect to the wheel axis) wide enough to allow the passage of the wheel and/or of the wheel's joint interface with the rocker. This makes it possible to guarantee the assembly/disassembly of the wheel when the wheel is radial (i.e., conventionally for forks that are not single-arm) while keeping the position of the caliper support as close as possible to the wheel to optimize the compactness and mass of the assembly.

According to a particular embodiment, the device has a half-moon-shaped part, called a half-moon, making it possible on the one hand to ensure the mounting and position of the joint between the caliper support and the rocker, and on the other hand the mounting and position of the wheel, all without interaction between one another. In the case of a caliper support in the interior position (i.e., between the wheel and the rocker), the joint between the caliper support and the rocker is made by a rolling bearing mounted in the caliper support and sliding without play around the interface provided on the rocker. The half-moon is a narrow cylindrical part (of the thick washer type), having a radial opening sufficient for the passage of the wheel and/or its mounting interface, and a shape complementary to the wheel and/or its mounting interface at its center. Its external face (the one directed toward the rocker) abuts on the one hand on the connecting device between the caliper support and the rocker (the rolling bearing or other bearing), and on the other hand on the face of the rocker, which is the interface between the rocker and the wheel and/or its mounting interface. The half-moon is fixedly mounted relative to the rocker (for example, via screws). The half-moon thus guarantees the position and the non-disassembly of the joint between the caliper support and the rocker, but also the assembly/disassembly and the position of the wheel. This solution guarantees a maximum compactness of the system. In a simplified manner, the half-moon can be replaced by at least two screws placed in such a way that their radial contact with the wheel or the fastening device of the wheel ensures the correct positioning of the wheel, and that the bearing surfaces of the screw heads overlap the interface between the rocker and the element connecting the caliper support to the rocker.

According to a particular embodiment, the mechanism according to the present disclosure is particularly suitable for the use of an external-type fork frame. In other words, the fork frame is hollow and receives between its inner faces the rocker and potentially the other elements (damper, torque link, etc.). The outer fork frame makes it possible to increase its inertial sections as much as possible, i.e., to optimize its mass/stiffness/resistance ratio. The internal elements (rocker and potentially the damper, the torque link, etc.) are then protected from external sources of damage, thus increasing the reliability of the system. The outer frame must at least have openings for the passage of the external movable elements connected to the rocker and other internal elements, such as the caliper support, the brake caliper and the elements of the wheel that pass through its volume. Advantageously, this outer frame also has access for tightening the wheel axis, mounting/removing internal elements and adjusting the damper. This solution also has the benefit of an integrated, elegant design suitable for sports and leisure vehicles. Finally, this architecture is perfectly suited to the use of composite or other existing technologies for the production of a monocoque fork frame.

According to one particular embodiment, the caliper support is such that the interface of the brake caliper is located in the space below and/or in front of the wheel axis. Thus, the braking system does not interfere with the main connection of the rocker whose outer fork frame represents the widest part. The fork frame can then be brought closer to the brake disc, increasing the compactness of the system and reducing the cantilever related to the forces of the wheel. The system as a whole is ultimately optimized in terms of mass.

According to one particular embodiment, the device according to the present disclosure is of the single-arm type. In such a case, the rocker is unique and necessarily placed on the braking system side. The mounting of the wheel is carried out axially, which simplifies the joint interface between the caliper support and the rocker (the half-moon is no longer needed). The lateral compactness of the system is further optimized.

According to a particular embodiment, the device uses a leaf spring, which is perfectly suited to the rotational kinematics of the rocker or the torque link. The leaf spring is therefore linked by joints adapted to its operation, both to the fork frame and to the rocker or to the torque link on a zone located at the rear (i.e., toward the rear wheel) of their joint with the rocker.

### BRIEF DESCRIPTION OF THE DRAWINGS

The attached drawings illustrate the present disclosure:

FIG. 1 shows a simplified lateral view of a cycle equipped with the front suspension that is an object of the present disclosure.

FIG. 2 shows a simplified perspective view of a cycle equipped with the front suspension that is an object of the present disclosure.

FIG. 3 shows a simplified side view of an embodiment of the present disclosure. The fork frame is shown there in cross-section in order to view the main internal elements and their joints/axes are identified therein.

FIG. 4 shows a kinematic diagram of an embodiment of the present disclosure. The main internal elements and their joints/axes are identified therein.

FIG. 5 shows a simplified front perspective view of the present disclosure. For more visibility, the fork frame and the elements of the wheel that are not interacting with the suspension are not shown therein.

FIG. 6 is identical to FIG. 5 but without the representation of the standard elements of the wheel and the brake caliper.

FIG. 7 shows a simplified rear perspective view of an embodiment of the present disclosure. For the sake of easier reading, the fork frame and the elements of the wheel that are not interacting with the suspension are not shown therein.

FIG. 8 is identical to FIG. 7 but without the representation of the standard elements of the wheel and brake caliper.

FIG. 9 is a front cross-section view at the wheel axis, which makes it possible to view the lateral arrangement of the parts.

FIG. 10 shows the interface zone between the wheel and the rocker.

FIG. 11 shows the interface zone between the rocker and the caliper support.

FIG. 12 shows the assembly between the rockers and the wheel.

FIG. 13 shows the positioning role of the half-moon.

FIG. 14 is identical to FIG. 10 with the half-moon replaced by two screws.

FIG. 15 is identical to FIG. 13 with the half-moon replaced by two screws.

FIG. 16 shows the internal elements transparent through the outer fork frame.

FIG. 17 shows the internal elements via a cross-section of the fork frame.

FIG. 18 shows the lower position of the brake caliper and the corresponding clearance of the fork frame.

FIG. 19 shows in a rear view, the arrangement of the fork frame as close as possible (compact) to the brake disc by virtue of the lower position of the brake caliper.

FIG. 20 shows the rear upper position of the brake caliper and the corresponding clearance of the fork frame.

FIG. 21 shows in a bird's-eye rear view, the arrangement of the fork frame as close as possible (compact) to the brake disc in the case of a high rear position of the brake caliper.

FIG. 22 is a front sectional view that shows the lateral arrangement of the parts in the case of a single-arm assembly.

FIG. 23 is a front perspective view that shows, in transparency, the tension leaf spring through the fork frame.

FIG. 24 is a front perspective view that shows the tension leaf spring via a cross-section of the fork frame.

FIG. 25 is a side view that shows the tension leaf spring via a cross-section of the fork frame.

For greater clarity, identical or similar elements (i.e., those with the same function(s)) of the various figures are denoted by identical reference signs in all of the drawings. The parts are identified by numbers, and their joints/axes identified by upper case letters. The lowercase letters associated with numbers represent information related to the part with the same number.

### DETAILED DESCRIPTION

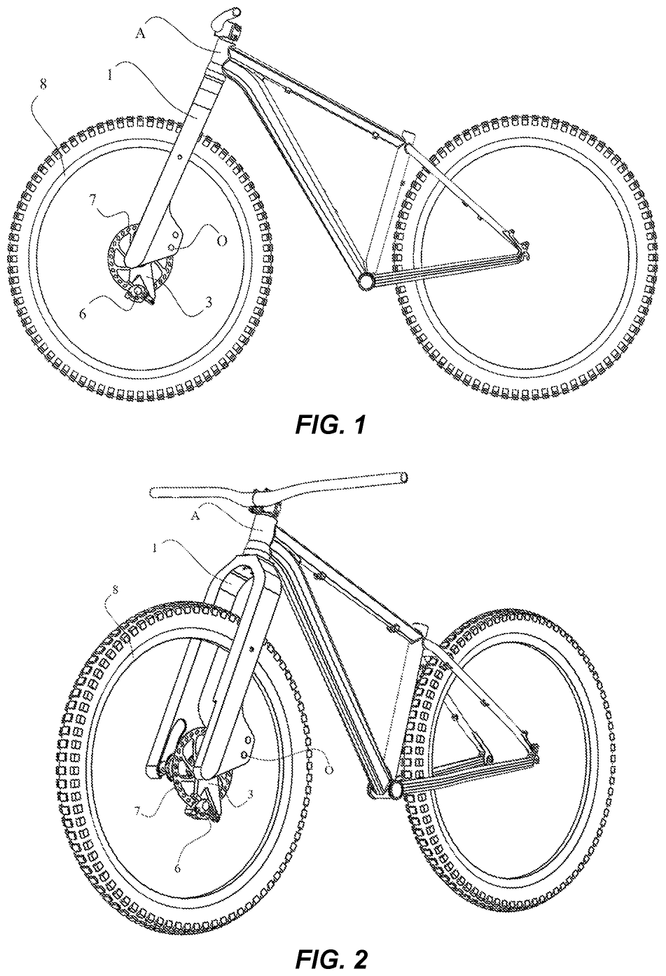

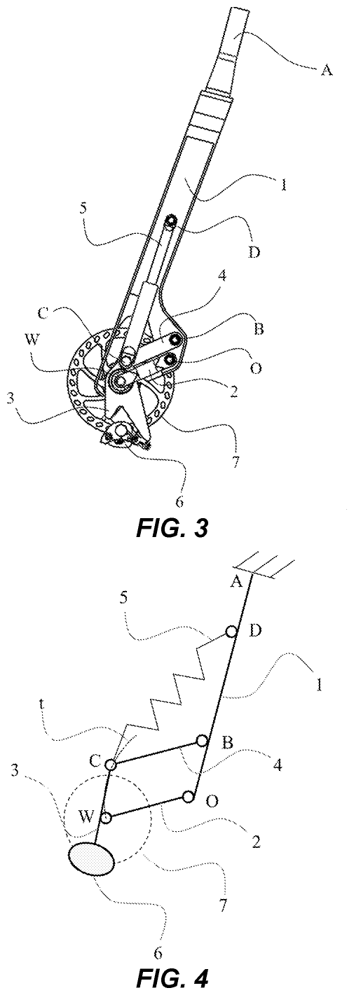

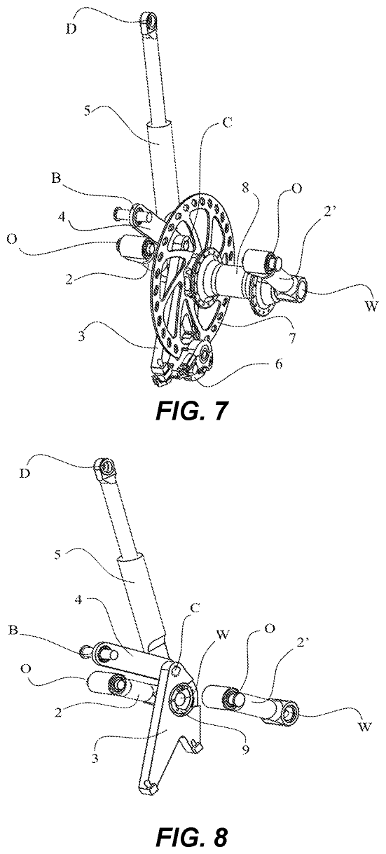

FIGS. 1-19 represent a first embodiment of the present disclosure with an inner caliper support in the low position, the damper connected directly to the caliper support with coaxial damper and torque link joints, an outer fork frame made a single piece and use of the half-moon to manage the wheel/rocker/caliper support interface.

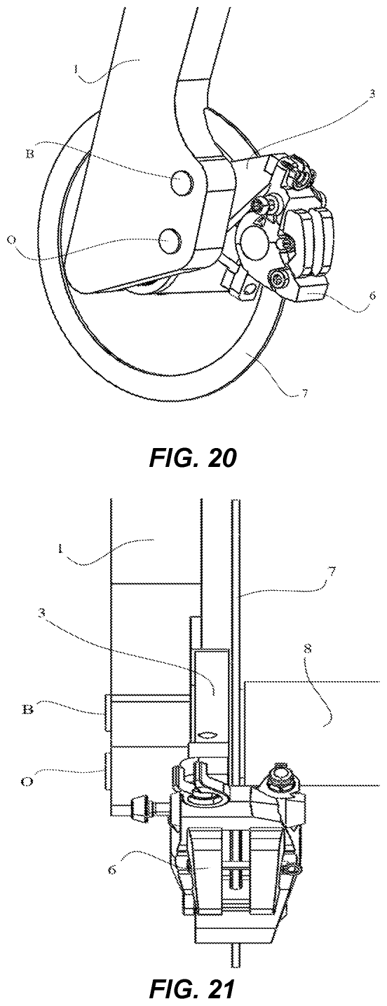

FIGS. 20 and 21 represent a second embodiment with the brake caliper in the upper rear position.

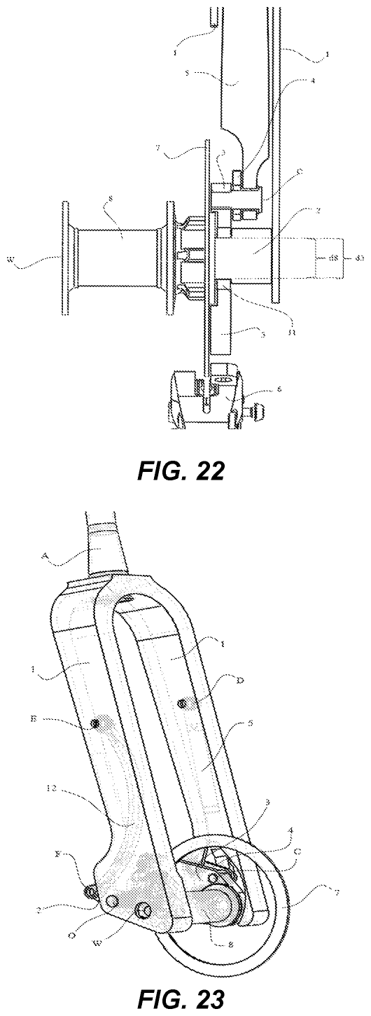

FIG. 22 represents a third embodiment with a single-arm architecture.

FIGS. 23-25 represent a fourth embodiment using a tension leaf spring.

FIGS. 1 and 2 represent an embodiment of the present disclosure mounted on an all-terrain cycle. The elements that are interfaced thereto are indicated: The frame of the cycle connected to the present disclosure via its steering bushing whose pivot joint will be denoted (A) in the rest of the present disclosure, the wheel (8) and its brake disc (7), and finally the brake caliper (6). The central element of the present disclosure is also found, the caliper support (3). The axis (O) is the main axis of the single-pivot kinematics, i.e., the wheel axis (denoted (W) later) describes an arc centered on (O).

The device according to the present disclosure has a fork frame (1) connected on the one hand to the cycle frame by a standard pivot joint (A), and on the other hand to the rocker (2) by a pivot joint (O).

FIG. 4 shows the kinematic diagram of a particular embodiment, for which the caliper support (3) is connected on the one hand to the rocker (2) by a pivot joint (W), coaxial to the wheel axis, and on the other hand to the torque link (4) by a pivot joint (C). The torque link (4) is itself connected to the fork frame (1) by a pivot joint (B). For this particular embodiment, the spring or damper (5) is connected on the one hand directly to the caliper support (3) by a pivot joint (C) and on the other hand to the fork frame by a pivot joint (D). It will be noted that, for this specific embodiment, the joint on the one hand between the caliper support (3) and the torque link (4), and on the other hand that between the caliper support (3) and the damper (5) are coaxial and therefore both represented by (C). Finally, FIG. 4 shows the trajectory of the wheel (and therefore of its axis (w)) identified by (t). (t) is an arc centered on (O).

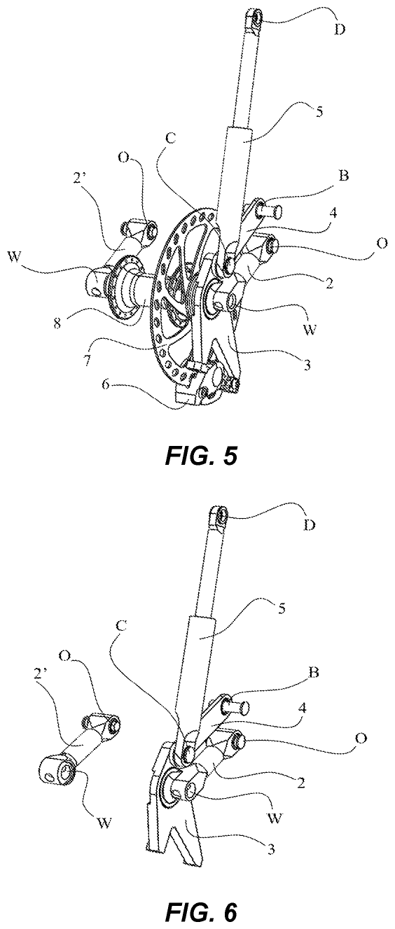

FIG. 5 shows a perspective view of the preceding embodiment without the fork frame (1). The wheel (8) (the parts not useful to the understanding of the present disclosure are not shown therein) and its brake disc (7) are identified in that figure. This embodiment being of the “double-rocker” type (i.e., non-single arm and having a rocker in two separate parts, one left and the other right), the right rocker (2′) is shown there. It will be noted that the axes (w) and (O) are noted in an identical manner on the left rocker (2) and the right rocker (2′) since they are effectively combined; this is necessary for the operation of the mechanism. In other words, the kinematics of the right rocker (2′) are strictly identical to the kinematics of the left rocker (2). According to this embodiment, the function of the right rocker (2′) is only to participate in the transmission of the guide forces between the fork frame (1) and the wheel (8) and to ensure the geometric stability of the wheel axis (W). Finally, FIGS. 5 and 6 make it possible to view the coaxial assembly (C) of the damper (5) and of the torque link (4) on the caliper support (3).

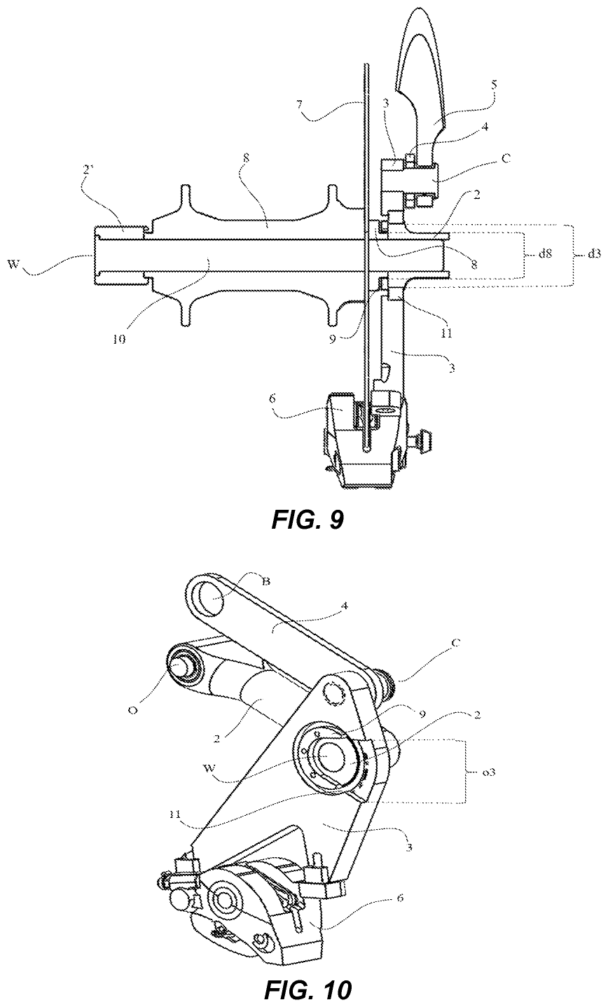

FIG. 9 makes it possible to view a mode of assembly of the preceding parts by means of standard elements of the rolling and bearing type. In particular, the damper (5) connected to the caliper support (3) is identified by means of an axis (C) screwed into the caliper support (3) and equipped with a bearing (not marked) ensuring the rotation interface between the axis (C) and the damper (5). Inserted between the caliper support (3) and the damper (5), the torque link (4) is identified, the element of which ensuring its interface with the axis (C) is a rolling bearing (not marked). There is therefore indeed a double coaxial joint. As for the caliper support (3), its interface can be seen with the rocker (2) provided by the rolling bearing (11). As specified in the preceding description, the interface of this bearing (11) with the rocker (2) is indeed located on a diameter (d3) greater than the diameter (d8) of the mounting interface between the wheel (8) and the rocker (2). Thus, the wheel (8) is not in contact with the caliper support (3), and it is indeed in direct contact and in an embedded connection with the rocker (2) (this connection will be detailed further on). The half-moon (9) is also identified, which ensures the positioning of the bearing (11) but also of the wheel (8). Its operation will be detailed later.

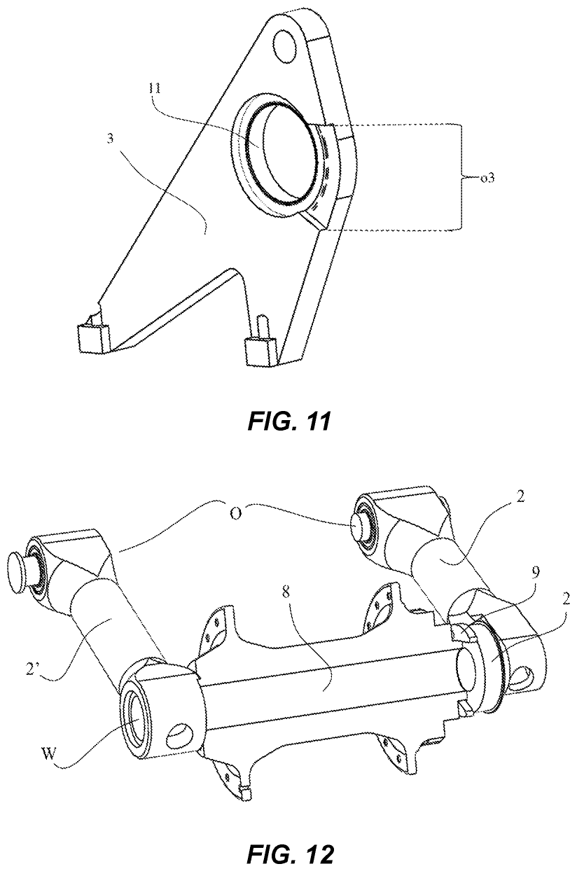

FIG. 9 shows the compatibility of the interface diameters (d8) and (d3) necessary for the disassembly of the wheel (8). However, if searching for maximum compactness, i.e., by bringing the caliper support (3) as close as possible to the brake disc (7), this is not sufficient. To this end, the caliper support (3) must have an opening (o3) (shown in FIG. 10) to allow the radial passage of the wheel (8) during its mounting or removal. FIG. 10 makes it possible to view the site of interface of the wheel (8) with the rocker (2) and the half-moon (9). Only the central face of the half-moon (9) and the inner face of the rocker (2) are in contact with the wheel (8) in operation. FIG. 11 makes it possible to view the single interface of the caliper support (around this mounting zone), which is done with the rocker (2) via the bearing (11). The caliper support (3) has no contact with the wheel (8) nor the half-moon (9).

FIG. 12 shows how the wheel (8) is connected with a joint (connection) of the embedded type with the rocker (2). In the present case, the two rockers (2) and (2′) are connected to the wheel (8) by planar supports, and then the axis (W) (not shown) passes through the two rockers (2) and (2′) and the wheel (8), which therefore ensures the axial joint. By friction, the tightening of the axis (W) ends up eliminating any degree of freedom. The assembly of the two rockers (2) and (2′) and wheel (8) therefore form a single piece from a kinematic point of view.

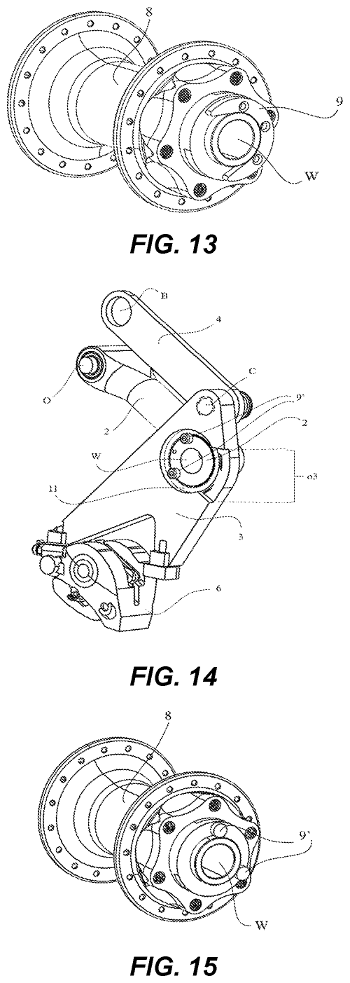

FIG. 13 specifies the interface between the wheel (8) and the half-moon (9) and thus explains the positioning of the wheel (8) by virtue of this system. FIGS. 14 and 15 show that it is easy to replace the half-moon (9) with two screws (9′) to perform the same function but in a simpler way.

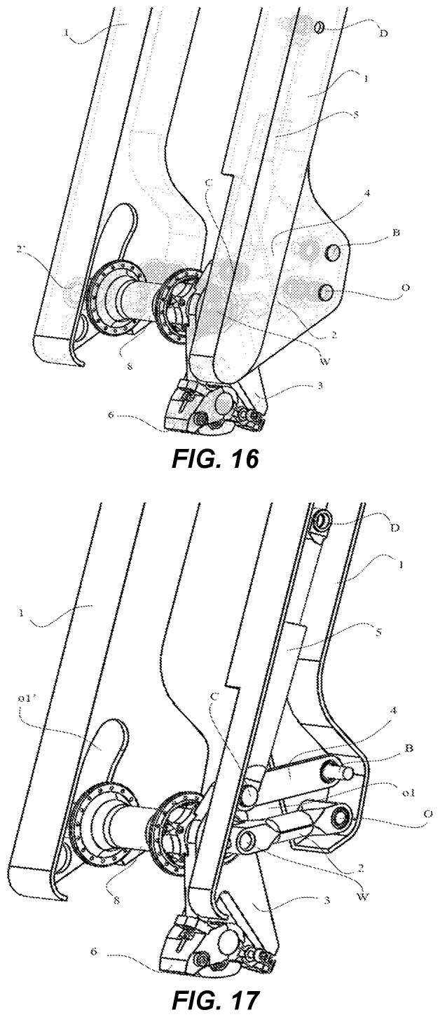

FIGS. 16 and 17 show how all of the elements of the present disclosure can be integrated into an outer frame (1). The term “outer frame” is understood to mean a hollow part receiving the main parts such as the rocker (2) on its inner faces. Here, all of the elements (except for the caliper support (3) are integrated into the outer frame (1)). Thus, the various parts, and, in particular, the rolling bearings, other bearings and seals of the damper, are protected from external elements (impacts, UV, water, etc.). The other advantage of this embodiment is to optimize the mass/stiffness ratio of the fork frame (1). Indeed, hollow parts of the monocoque type are known for their great rigidity and lightness thanks to the optimization of their inertial sections. It will be noted that the fork frame (1) necessarily has openings (o1) and (o1′) allowing the passage of the mobile elements or for access to different internal parts during assembly or adjustment. This type of opening is shown in FIG. 23 at the wheel axis (w).

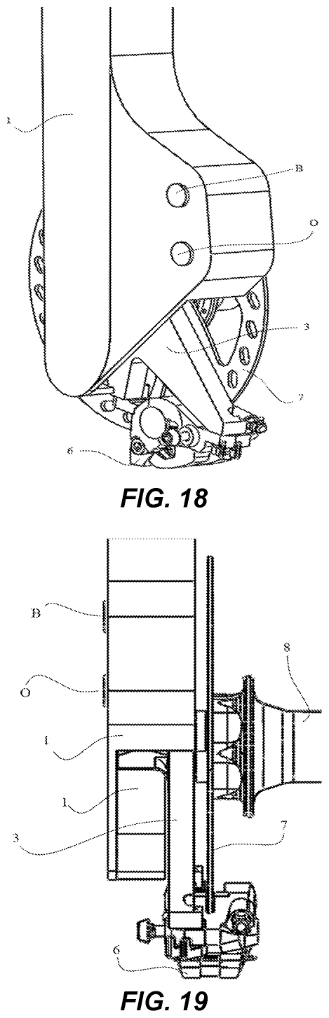

According to the embodiment described above, the brake caliper is placed in the low position in order to optimize the lateral compactness of the assembly. FIG. 18 shows the necessary release under the fork frame (1) for the passage of the caliper support (3) and the caliper (6), and FIG. 19 shows that this position makes it possible to bring the inner face (i.e., toward the wheel (8)) closer to the fork frame (1) and the inner face of the caliper support (3) of the brake disc (7); these two faces then being coplanar.

FIGS. 20 and 21 show another embodiment for which the brake caliper is placed in the rear high position. It can be seen therein that no release under the fork frame (1) is necessary, which is an advantage for its structure, but that the presence of the caliper support (3) between the disc (7) and the frame (1) (in fact more precisely the joint (O) of the frame (1)) limits the compactness.

FIG. 22 shows an embodiment of the single-arm type. This makes it possible to dispense with problems of assembly/disassembly of the wheel (8), as its installation requires only axial movements. In this case, the function of the half-moon type is no longer necessary and the lateral compactness can be maximal. It is shown in this figure that the interface diameters (d8) and (d3) of the wheel (8) and of the caliper support (3) can be strictly identical.

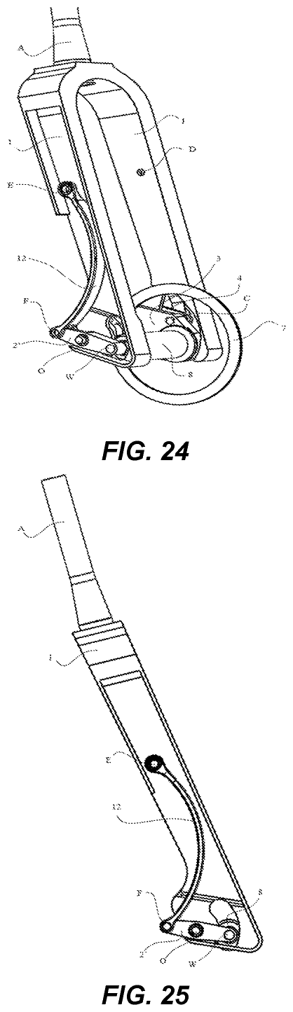

FIGS. 23 and 24 show an embodiment using a tension leaf spring (12), here mounted on the side opposite the brake. Tension leaf springs (12) have large advantages (adjustability, lightness, reliability, etc.) but cannot generally be used on conventional kinematics since they must be placed in tension and not compression. The rocker arm of the present disclosure is perfectly suited to the use of this type of spring. In the present embodiment, the tension leaf springs (12) linked on the one hand to the frame (1) by a pivot (or ball) joint (E), and on the other hand to the rocker (2′) by a pivot (or ball) joint (F) located at the rear (i.e., toward the rear wheel) of the joint (O). As can be seen in these figures, the leaf spring (12) can be totally or partially integrated with the frame (1).

The present disclosure (and its various embodiments) is particularly suitable for the production of a front suspension of a cycle, bicycle, motorcycle, two-wheeled vehicle or equivalent.

The present disclosure is described in the foregoing by way of example. It is understood that a person skilled in the art is able to produce different variant embodiments of the present disclosure.

### LIST OF REFERENCE SIGNS

(1) Fork frame
(2), (2′) Rocker(s)
(3) Caliper support
(4) Torque link
(5) Damper (or spring, i.e., the dissipative and/or resilient element)
(6) Brake caliper
(7) Brake disc
(8) Wheel
(9) Half-moon
(9′) Screws serving the function of the half-moon
(10) Wheel axis (the part necessary for mounting the wheel)
(11) Interface bearing between the caliper support (3) and the rocker (2)
(12) Tension leaf
(A) Joint between (1) and the vehicle frame
(B) Joint between (1) and (4)
(C) Joint between (3) and (4)
(D) Joint between (1) and (5)
(E) Joint between (1) and (12)
(F) Joint between (2) or (2′) and (12)
(0) Joint between (1) and (2)
(W) Joint between (2) and (3) or representation of the wheel axis
(t) Wheel path along (W)
(d3) Interface diameter between (3) and (2)
(d8) Interface diameter between (8) and (2)
(o3) Opening onto the part (3)
(o1) and (o1′) Openings onto the part (1)

1. A suspension device for a front steering wheel for a vehicle with two or more wheels, comprising a fork frame connected to the steering column of the vehicle by a standard pivot joint configured to ensure the degree of freedom necessary for the transmission of the vehicle guide movements, a rocker connected to the fork frame by a pivot joint whose axis of rotation is parallel to the axis of rotation of the wheel and located behind the axis of rotation of the wheel, and to the wheel, and a dissipative and/or resilient system installed between all relatively moving parts of the suspension device, wherein the suspension device has a caliper support with an interface compatible with the mounting of a standard brake caliper, the caliper support connected to the rocker by a pivot joint coaxial with the wheel axle, and to a torque link by a pivot or ball joint, the torque link being connected to the fork frame by a pivot or ball joint such that the segments connecting these joints and the joint of the rocker to the fork frame form a non-intersecting convex quadrilateral with one degree of freedom allowing movement of the wheel axle in a plane normal to its direction.

2. The suspension device according to of claim 1, wherein the dissipative and/or resilient system is connected directly to the caliper support by a joint selected from among a pivot joint, a ball joint, a flexible joint, or an embedded joint.

3. The suspension device of claim 2, wherein the joints on the caliper support of the dissipative and/or resilient system and of the torque link are coaxial.

4. The suspension device of claim 3, wherein the caliper support is positioned on an inner side of the rocker between the rocker and the wheel, and such that the joint interface between the caliper support and the rocker is located on a diameter greater than or equal to that of the joint interface between the wheel and the rocker.

5. The suspension device of claim 4, wherein the caliper support and/or the joint interface between the caliper support and the rocker has/have a radial opening, relative to the axis of the wheel, sufficiently wide to allow passage of the wheel and/or the joint interface of the wheel with the rocker.

6. The suspension device of claim 4, wherein the joint between the caliper support and the rocker comprises a bearing mounted in the caliper support and configured to slide without play around the interface provided on the rocker.

7. The suspension device of claim 6, wherein:
the device has a half-moon with a narrow cylindrical shape, having a radial opening sufficient for the passage of the wheel and/or of its mounting interface, and a shape complementary to the wheel and/or its mounting interface in its center which makes it possible to ensure the positioning of the wheel during its mounting,
the external face of the half-moon abuts the bearing which forms the joint between the caliper support and the rocker, and the face of the rocker which is the interface between the rocker and the wheel and/or its mounting interface,
the half-moon is fixedly mounted relative to the rocker.

8. The suspension device of claim 1, wherein:
the fork frame is hollow and receives between its inner faces at least the rocker,
the fork frame has at least openings for the passage of the mobile elements that are external to the fork frame and connected to the rocker, and
the fork frame has at least openings for access to the wheel axis.

9. The suspension device of claim 1, wherein an interface between the caliper support and the brake caliper is located in a space below and/or in front of the axis of the wheel.

10. The suspension device of claim 1, wherein the dissipative and/or resilient system comprises a tension leaf spring linked by joints to the fork frame, and to the rocker or the torque link in a zone located at the rear of their joint with the fork frame.

11. The suspension device of claim 1, wherein the caliper support and/or the joint interface between the caliper support and the rocker has/have a radial opening, relative to the axis of the wheel, sufficiently wide to allow passage of the wheel and/or the joint interface of the wheel with the rocker.

12. The suspension device of claim 1, wherein the caliper support is positioned on an inner side of the rocker between the rocker and the wheel, and such that the joint interface between the caliper support and the rocker is located on a diameter greater than or equal to that of the joint interface between the wheel and the rocker.

13. The suspension device of claim 12, wherein the joint between the caliper support and the rocker comprises a bearing mounted in the caliper support and configured to slide without play around the interface provided on the rocker.

14. The suspension device of claim 13, wherein:
the device has a half-moon with a narrow cylindrical shape, having a radial opening sufficient for the passage of the wheel and/or of its mounting interface, and a shape complementary to the wheel and/or its mounting interface in its center, which makes it possible to ensure the positioning of the wheel during its mounting,
the external face of the half-moon abuts the bearing, which forms the joint between the caliper support and the rocker, and the face of the rocker, which is the interface between the rocker and the wheel and/or its mounting interface,
the half-moon is fixedly mounted relative to the rocker.

15. A vehicle, comprising:
a front steering column;
a front wheel; and
a suspension device coupled to the front steering column and the front wheel, the suspension device comprising:
a fork frame connected to the front steering column by a pivot joint;
a rocker having a first end connected to the fork frame by a pivot joint having an axis of rotation parallel to an axis of rotation of the front wheel and located behind the axis of rotation of the front wheel, the rocker having a second end connected to the front wheel;
a caliper support configured to support a brake caliper thereon, the caliper support connected to the second end of the rocker by a pivot joint coaxial with the axis of rotation of the front wheel;
a torque link connected to the caliper support by a pivot or ball joint, the torque link also connected to the fork frame by a pivot or ball joint;
wherein the fork frame, the rocker, the caliper support, and the torque link form a quadrilateral configured to allow translational movement of the front wheel with only one degree of freedom in a plane normal to the axis of rotation of the front wheel; and
a dissipative and/or resilient system connected between the fork frame and the caliper support.
